(19) United States
(12) Patent Application Publication
(10) Pub. No.: US 2006/0221233 A1
(43) Pub. Date: Oct. 5, 2006

(54) Audio Modifications in Digital Media Decoders

(76) Inventor: Freimann Felix, Sunnyvale, CA (US)

Correspondence Address: NORTH AMERICA INTELLECTUAL PROPERTY CORPORATION, P.O. BOX 506, MERRIFIELD, VA, 22116, US

(21) Appl. No.: 10/907,443

(22) Filed: Apr. 1, 2005

(51) Int. Cl. H04N 11/00

(52) U.S. Cl. 348/462

(57) ABSTRACT

A demodulated signal in a digital media system includes an audio bitstream that is transmitted to an audio decoder and program information that includes program content category. A plurality of customizable sets of data that identify desired modifications to audio characteristics are respectively associated with specific program content categories. Program content category information is obtained from the received program information and the audio modification data set associated with that program content category is applied to the decoded audio signal before output.

### BACKGROUND OF INVENTION

1. Field of the Invention

The present invention is concerned with modifying audio characteristics within a digital media decoder (such as a digital television decoder), and more specifically with applying specific audio modifications to the audio component of a received signal according to program content category.

2. Description of the Prior Art

Several new standards are currently being developed to bring increased video resolution and higher audio quality to digital television transmission systems to meet customer demand. Although the proposals provide vastly improved entertainment opportunities over current broadcast TV, the number of user definable options remains un-optimized over the current system. The present invention is directed toward allowing the user to personally customize audio enhancements utilizing untapped information embedded within the transmitted signal.

### SUMMARY OF INVENTION

The claimed invention includes a tuner for physical selection of a broadcast channel from a received signal in a digital media system, such as a digital television system. The selected signal is transmitted to a demodulator that converts the selected signal into a digital transport stream and forwards the transport stream to a signal processor, which separates the transport stream into a video bitstream, an audio bitstream, a clock data component, and program data component.

An audio decoder decodes the audio bitstream and the decoded audio signal is outputted to an audio device via an audio processor. The program data is forwarded to an information module that obtains, from the received program data, a content descriptor indicating to which of a predefined plurality of content categories the current program is categorized. The present invention allows a user to predefine a plurality of customized sets of data that identify desired modifications to sound characteristics and associate the customized sets of data with specific program content categories. A lookup table in a memory may be utilized to store the associations. According to the program content as specified in the content descriptor, the customized set of audio modification data associated with that specific program content category is applied to the decoded audio signal before output to the audio device. A default set of audio modification data is defined for use when no customized data set has been associated with an indicated program content category or when the content descriptor is absent or corrupted.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional block diagram of a digital TV decoder system according to the present invention.

FIG. 2 is a functional block diagram of the Audio Processor of FIG. 1.

FIG. 3 is a simplified example program information table.

FIG. 4 is a simplified example user input interface.

### DETAILED DESCRIPTION

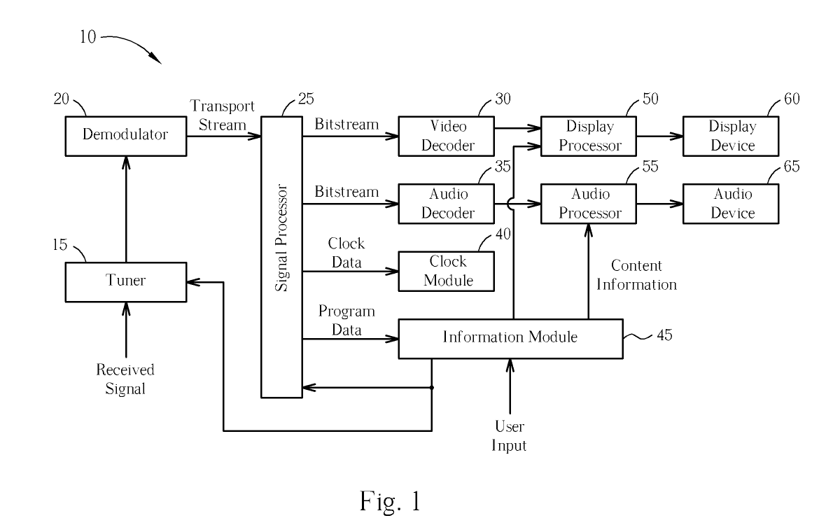

Please refer to FIG. 1, which is a functional block diagram of an Advanced Television Systems Committee (ATSC) digital TV decoder system 10 when employing the teachings of the present invention. As is known to those skilled in the art, other digital systems, such as Digital Video Broadcasting (DVB), may be used in various locations around the world and the decoder system 10 is merely an example of one such classification and not to be construed as limiting the scope of the present application to ATSC systems.

The digital decoder 10 comprises a tuner 15 for physical selection of a TV channel from a received signal. The selected signal is transmitted to a demodulator 20, which converts the selected signal into a digital transport stream and forwards the transport stream to a signal processor 25. The signal processor 25 separates the transport stream into a video bitstream, an audio bitstream, a clock data component, and program data component.

The video bitstream is forwarded to a video decoder 30 (normally MPEG-2 or other compression scheme) from which the decoded signal is outputted to a display processor 50 for further processing and eventually exhibited on a TV screen or other video display device 60.

The audio bitstream is decoded by an audio decoder 35 (normally AC-3 but is not limited to AC-3) and the decoded audio signal is outputted to speakers or another audio device 65 such as an audio home entertainment system. The current specifications stipulate minimum audio qualities and normally comprise at least 5.1 channels to provide state of the art audio. The audio processor 55, shown in FIG. 1 as between the audio decoder 35 and the audio device 65, will be discussed in detail later.

A clock module 40 utilizes the received clock data to synchronize the decoder's clock with the clock of the encoder and to correct for timing or other errors in the received signal.

The program data is forwarded to an information module 45 and comprises numerous tables and information that, among other things, can be presented to a user to give the user a wide range of choices concerning channel and/or program selection. Program data is equivalent to Program and System Information Protocol (PSIP) data in an ATSC system and Service Information (SI) in DVB. Much of the information and choices can be displayed on the video display device 60 and a selection by the user is utilized to control the tuner 15 and/or the signal processor 25 and/or the audio processor 55. For example, displayable transmitted information may include the name of the program, program duration, program content category, program advisories, closed caption options, choice of languages, and numerous other pieces of pertinent data.

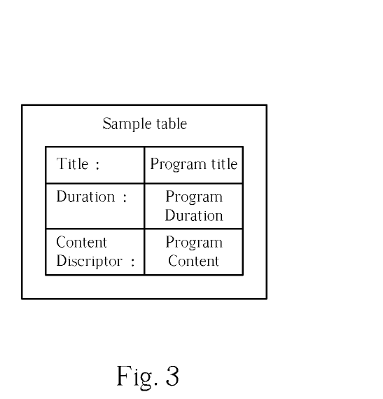

Depending on the type of digital system being utilized, a table called an Event Information Table (EIT) is normally included in the program data. A simplified illustration of an example EIT is shown in FIG. 3. The table includes fields for the title of the program, the duration of the program, and program descriptors, one of which may be a content descriptor indicating to which of a predetermined plurality of content categories the associated program is categorized. For example as in a DVB system, the content descriptor comprises two 4-bit fields categorizing the program into a specific type of entertainment. The first 4-bit field broadly categorizes the program by general type, such as “Movie”, “News/Current Affairs”, “Social/Political Issues/Economics”, “Education/Science/Factual Topics”, or “Leisure Hobbies”. The second 4-bit field further sub-categorizes the program within the general type. For example, a program defined as a “Movie” by the first 4-bit field may be sub-categorized such as a “Detective/Thriller”, “Science Fiction”, “Comedy”, “Romance”, or other predefined specifications by the second 4-bit field. Obviously when utilizing a total of 8 bits to define program content, the maximum number of possible defined categories is large (256), but limited.

Returning now to the audio aspect of the decoder system 10, the decoded audio bitstream is designed to provide high-quality sound characteristics to further enhance a user's entertainment pleasure. Many of these users are well versed in the pleasing potential of high quality sound and have invested heavily in the audio components of their home entertainment system. Most users are aware that customizing the characteristics of the received audio signal according to personal taste further enhances the listening pleasure. For example, an equalizer may be used to emphasis certain frequencies to improve bass response, naturalize speech, or any of a range of similar sound modifications. Additionally, some devices are capable of modifying sound characteristics so that the sound more closely mirrors sound heard in a specific environment, such as a sports arena as opposed to a concert hall. Both environmental effects and frequency modifications can be accomplished either via hardware or software arrangements.

The present invention is directed toward allowing a user to predefine a plurality of customized sets of data that define modifications to sound characteristics and respectively associate desired audio modification data sets with, and apply to, various categories of program content. For example, say the user makes an association between the program content bits indicating “Further Education” and settings that modify the audio to mirror the sound as produced in a closed classroom. Additionally, the user makes the association between the program content bits indicating “Gardening” and settings that modify the audio to mirror the sound as produced in an open outdoor environment. When the user is viewing a “Further Education” program, the present invention recognizes the program content descriptor in the program data and automatically modifies the audio portion of the program utilizing the user defined audio modification data set, that of a closed classroom. When the user switches channels or a new program begins and the program content bits of the new program indicate that it is a “Gardening” program, the present invention recognizes the different program content bits and applies the associated audio modification data set to modify the audio to now mirror the sound as produced in an open outdoor environment. Obviously, these choices of settings may be customized by the user to be either the same or different from this example.

Additionally, there preferably is a default set of audio modification data that can be utilized when the user has not made an association for a specific program content descriptor or when the program content descriptor is missing or corrupted. This default set of data may be preset by the manufacturer and/or be programmable by the user.

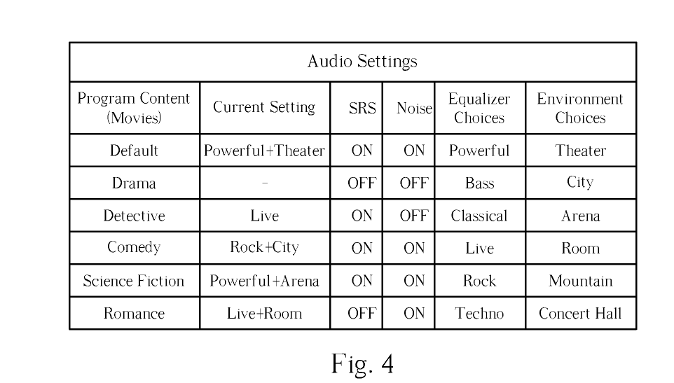

An example user input interface is shown in FIG. 4 that can be displayed on the display device 60, allowing a user to view and/or edit associated audio qualities with a specific program content descriptor. It is to be understood that the interface illustrated in FIG. 4 is merely one example to aid in the understanding of the present invention and is not intended to limit the scope of the claims to the specific content, arrangement, or usage shown.

The “Program Content” column can comprise a list of content names associated with specific program content bits, plus a default. The list of content bits and content name associations can be stored in a memory of the digital TV decoder system 10, preferably in the information module 45 or the audio module 55, but it is not necessary to do so and may be retrieved or generated in a variety of ways. The “Current Setting” column shows the names of audio modification data sets currently associated with each content name. Obviously, the number of content names and permitted associations may be a matter of design choice in any given system.

Shown to the right of the “Current Setting” column are a series of available choices from which a user may choose to customize audio for each of the listed content names. The “SRS” and “Noise” columns respectively toggle a sound retrieval system and noise reduction filters on and off for each content name. The “Equalizer Choices” column provides a list of available, predefined audio modification data sets that utilize an equalizer to emphasis desired frequency ranges. Utilizing a conventional click-and-point or similar selection process, any of these equalizer choices may be associated with any of the content names. A non-exhaustive list of example equalizer choices is shown in the illustration.

Similarly, the “Environment Choices” column provides a list of available and user selectable, predefined audio modification data sets that utilize audio filters or other methods to modify the audio so as to approximate the sound as produced in the selected environment. These choices may be used alone or in addition to selected equalizer choices, or obviously, a content name may have no associated audio modification data set if desired, as shown by the unassigned indicator entered next to the “Drama” content name. In this example case, when the program content bits indicate that the current program is a Drama, one embodiment of the present invention would utilize the “Default” currently associated audio modification data sets of “Powerful+Theater”, while another embodiment may simply not apply any audio modification data set (because none has been assigned) and pass the decoded audio signal on to the audio device 65 unaltered. Either or both of the Equalizer Choices and Environment Choices columns may also comprise a user-definable choice, which if selected would allow the user to create or modify a user customized audio modification data set, such as allowing individual frequency range modifications in the case of a customized equalizer choice or applying various filters or other desired modifications in the case of a customized environmental choice.

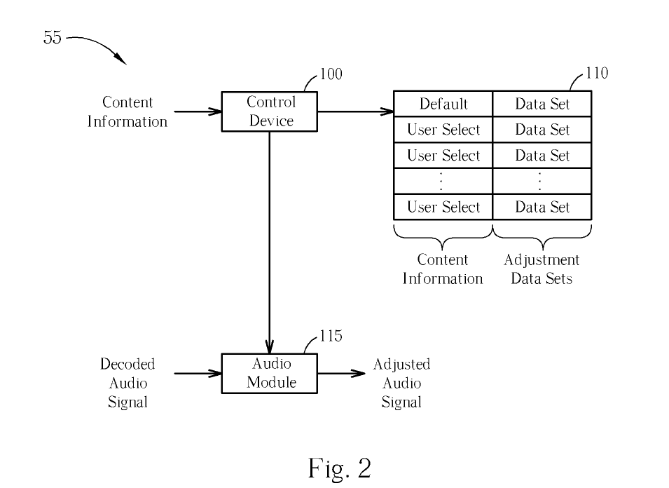

Referring now to the audio processor 55, please refer to FIG. 2. Content information, in the form of either content name or content bits, is forwarded via the information module 25 to a control device 100 for processing. The control device 25 has access to a memory 110 and may be a microprocessor executing code stored in memory or perhaps a ROM and hardware based circuit. The memory 110 preferably comprises a lookup table where the inputted content information is utilized to obtain the previously associated audio modification data set. It is to be noted that associated audio modification data set may be actually data describing specific modifications or may be pointers to specific modifications comprised by a predefined library of possible modifications disposed in the memory 110 or other memory in the audio processor 55. Because the maximum number of content names is 256 due to the content bits being eight in number and may be considerably less due to design considerations, one embodiment of the present invention may utilize a control device 100 similar to a multiplexor that utilizes inputted content bits to output the associated audio modification data set. Another embodiment utilizes all or at least a portion of the content bits to form a memory address that holds a pointer to the desired audio modification data sets. Other methods may alternatively be used, again according to design considerations.

The specific method utilized to obtain the audio modification data set associated with inputted program content bits is not a key feature of the invention. A key feature of the invention is to obtain the associated audio modification data set and to transmit it to an audio module 115 where the specified modifications are applied to the decoded audio signal. The audio module 115 comprises an equalizer and/or audio filters, receives the decoded audio signal from the audio decoder 35, applies the obtained audio modification data set to the decoded audio signal, and outputs an audio signal to the audio device 65 that has been adjusted according to the audio modification data set.

As should be apparent, the various components 100, 110, 115 of the audio processor 55 may be grouped together as a separate unit as shown in FIG. 1, however, this is not a necessity. Different embodiments of the present invention relocate the memory 110, the control device 100, and/or the audio module 115 within the information module 45 and/or the audio device 65 to share resources with the information module 45 and/or the audio device 65 and reduce costs. Please note however, that all components in all embodiments are connected such that content information from the program data is received and utilized to access an audio modification data set from memory and that the accessed audio modification data set is applied to the decoded audio signal.

The present invention allows a user to predefine audio characteristics and associate that definition with specific program content categories. When the program content category changes due to changing of channels or programs, the audio modification data set associated with the new program content category is now automatically applied to the decoded audio signal, saving the user effort while permitting optimally customized audio in the digital entertainment experience.

Those skilled in the art will readily observe that numerous modifications and alterations of the device and method may be made while retaining the teachings of the invention. For example, a manufacturer or distributor predefining associations between content bits and audio modification data sets and forgoing allowing a user to redefine the associations is intended to remain within the teachings and scope of the present invention. Additionally, although the use of the EIT table is preferred, some digital TV systems include other tables or data within the program data that categorizes programs by content. The kernel of the present invention is to automatically apply a predefined audio modification set to the audio component of a received signal in a digital media system according to content information received in the program data component of the received signal. As such, utilizing program content information as described in this disclosure, regardless of the content information's specific location in the program data, should be interpreted as falling within the scope of the invention. Accordingly, the above disclosure should be construed as limited only by the metes and bounds of the appended claims.

What is claimed is:

1. A decoder module for decoding a received signal in a digital media system, the received signal comprising a video component, an audio component, and program content information classifying a current program into one of a plurality of predefined program content categories, the decoder module comprising:
an audio decoder for decoding the audio component of the received signal and outputting a decoded audio signal;
a memory comprising a plurality of audio modification data sets, each of the plurality of audio modification data sets comprising information utilized to modify audio characteristics; and
an audio processor connected to the audio decoder for receiving the decoded audio signal and obtaining one of the plurality of audio modification data sets selected according to the program content information of the received signal;
wherein the audio processor modifies the decoded audio signal according to the selected audio modification set and outputs the modified decoded audio signal.

2. The decoder module of claim 1 wherein one of the plurality of audio modification data sets is utilized as a default value.

3. The decoder module of claim 1 wherein the audio processor comprises an equalizer to emphasis selected frequencies of the decoded audio signal according to the selected audio modification set.

4. The decoder module of claim 1 wherein the audio processor comprises audio filters to apply an environmental effect to the decoded audio signal according to the selected audio modification set.

5. The decoder module of claim 1 wherein at least one of the plurality of audio modification sets is user programmable.

6. The decoder module of claim 1 wherein the program content information is received through a media broadcast system.

7. The decoder module of claim 6 wherein the program content information is signaled within Program and System Information Protocol data as defined in an Advanced Television Systems Committee specification or within Service Information as defined in a Digital Video Broadcasting specification.

8. The decoder module of claim 7 wherein the program content information comprises a content descriptor, the content descriptor comprising one or multiple bits to indicate the program content and at least a portion of the one or multiple bits are utilized in a memory address for obtaining the selected audio modification data set.

9. The decoder module of claim 1 wherein the memory comprises a lookup table for associating program content with an audio modification data set.

10. A method for receiving and decoding a media signal, the received signal comprising a video component, an audio component, and program content information classifying a current program into one of a plurality of predefined program content categories, the method comprising:
decoding the audio component into a decoded audio signal;
associating at least one of the predefined program content categories with at least one of a plurality of audio modification data sets;
reading the program content information in the received signal to determine current program content category;
modifying characteristics of the decoded audio signal according to the associated audio modification data set; and
outputting the modified decoded audio signal.

11. The method of claim 10 further comprising establishing one of the plurality of audio modification data sets as default values associated with program content categories having no other associated audio modification data set.

12. The method of claim 10 wherein the characteristics of the decoded audio signal are modified by emphasizing selected frequencies within the audio component.

13. The method of claim 10 wherein the characteristics of the decoded audio signal are modified utilizing audio filters to introduce an environment effect to the audio component.

14. The method of claim 10 wherein the program content information is comprised by a content descriptor within Program and System Information Protocol data as defined in an Advanced Television Systems Committee specification or within Service Information as defined in a Digital Video Broadcasting specification.

15. The method of claim 10 wherein at least one of the associations between program content categories and the plurality of audio modification sets is user programmable.

16. A device for receiving and decoding a media signal, the received signal comprising a video component, an audio component, and program content information classifying a current program into one of a plurality of predefined program content categories, the device comprising:
an audio decoder for decoding the audio component and outputting a decoded audio signal;
means for associating at least one of the predefined program content categories with at least one of a plurality of audio modification data sets;
means for obtaining current program content category from the program content information in the received signal; and
means for modifying characteristics of the decoded audio signal according to the associated audio modification data set.
